(19) United States
(12) Patent Application Publication
(10) Pub. No.: US 2025/0062845 A1
(43) Pub. Date: Feb. 20, 2025

(54) CELLULAR COMMUNICATION SYSTEM FEATURING ADVANCED SON FUNCTIONALITY

(71) Applicant: Telecom Italia S.p.A., Milano (IT)

(72) Inventors: Simone BIZZARRI, Torino (IT); Gianluca FRANCINI, Torino (IT); Giorgio GHINAMO, Torino (IT); Giuseppe MINERVA, Torino (IT)

(73) Assignee: Telecom Italia S.p.A., Milano (IT)

(21) Appl. No.: 18/724,211

(22) PCT Filed: Dec. 14, 2022
(86) PCT No.: PCT/EP2022/085982

§ 371 Date: Jun. 26, 2024

(30) Foreign Application Priority Data
Dec. 29, 2021 (IT) 102021000032966

(51) Int. Cl. H04B 17/391; H04B 17/382; H04W 24/04

(52) U.S. Cl. CPC H04B 17/3912; H04B 17/382; H04W 24/04

(57) ABSTRACT

A method for configuring a cellular network including measuring values of at least one performance indicator over a plurality of time intervals, the plurality of time intervals comprising a current time interval and a plurality of historical time intervals; determining, for each historical time interval, a plurality of alternative network configurations; determining, for each alternative network configuration, simulated values of the at least one performance indicator; based on the measured historical and simulated values of the at least one performance indicator, determining, for each selected historical time interval, a best network configuration; based on the current and measured historical values of the at least one performance indicator, determining forecast values of the at least one performance indicator for a following time interval; based on the forecast values, predicting an optimal network configuration for the following time interval and configuring the cellular network according to the predicted optimal network configuration.

### BACKGROUND OF THE INVENTION

### Field of the Invention

The present invention generally relates to wireless communication systems, such as cellular communication systems (for example, 3G, LTE/LTE-Advanced and 5G cellular communication systems). Particularly, the present invention relates to cellular communication systems featuring “Self-Organizing Network” (SON) functionalities.

### Overview of the Related Art

A conventional cellular communication system comprises a cellular network. The cellular network typically comprises a plurality of cellular communication equipment, each one providing radio coverage over one or more portions of a geographic area, or network cells.

Each cellular communication equipment typically comprises one or more electronic apparatuses and one or more antennas, so as to allow user devices (such as mobile phones, smartphones, tablets, personal digital assistants and computers) within the respective network cells (and connecting/connected to the cellular communication system) to exchange data traffic (e.g., web browsing, e-mailing, voice, or multimedia data traffic).

Cellular communication systems exist which implement “Self-Organizing Network” (SON) functionalities.

According to SON principles, a configuration of the cellular network (hereinafter, network configuration) may be dynamically changed in order to achieve performance optimization.

Just as an example, SON functionalities based on CCO (“Coverage and Capacity Optimization”) algorithms allow changing antenna parameters of the cellular communication equipment (and, hence, the radio coverages of the respective network cells) according to a geographical distribution of the user devices, thereby allowing to optimally distribute an offered data traffic with respect to radio resources available at the network cells.

Just as another example, SON functionalities based on MLB (“Mobility Load Balancing”) algorithms allow user devices to be transferred from a network cell to a neighboring network cell by acting on handover and/or cell selection/reselection parameters and thresholds.

Changes in the network configuration performed through SON functionalities are typically based on observations and statistical processing of parameters relating to the operation of the cellular network (such as “Key Performance Parameters”, hereinafter KPI parameters) provided by proper monitoring apparatuses (such as performance counters) of the cellular network.

According to recent solutions, optimal network configurations are determined or estimated or predicted based on forecast KPI parameters. Forecast KPI parameters may for example be determined (e.g., by means of proper forecast procedures) based on historical KPI parameters collected over a long or relatively long monitoring time period.

U.S. Pat. No. 9,439,081 discloses a computer-implemented method of forecasting wireless network performance. The method comprises receiving historical performance data and baseline data for a cell in a network. The historical performance data may comprise a plurality of key performance indicators (KPIs). The method further comprises receiving, from a user, a selection of a first KPI in the plurality of KPIs, applying a machine learning model to the first KPI and at least one KPI in the plurality of KPIs, generating at least one model parameter based on application of the machine learning model, applying the baseline data to the at least one model parameter, calculating a predicted value of the first KPI for the cell in the network based on the application of the baseline data to the at least one model parameter.

U.S. Pat. No. 10,555,191 discloses a method for computing a standardized composite gain metric value for each solution that has been previously deployed to fix degradation issues at cell sites or other wireless nodes. The method selects a set of KPI parameters, each of which is highly correlated to customer experience. The method then assigns a weight to each KPI parameter, such that the weight reflects the relative importance of each KPI parameter and ensures that the KPI parameters are not double counted. For each solution deployed at a cell site, the method computes values of the following composite gain metrics: weighted gain and offload index. The method then can rank the solutions based on the computed composite gain metric values so that an optimal solution can be selected.

U.S. Pat. No. 9,456,362 discloses a system for network optimization. The system comprises a data collection system configured to collect geolocated subscriber records from a plurality of mobile devices. The system comprises a SON optimization system communicatively coupled to the data collection system via a network. The SON optimization system comprises at least one pre-processor configured to receive and process geolocated subscriber records from the data collection system. The SON optimization system further comprises a network simulator configured to perform network simulation analysis based on the processed geolocated subscriber records, and provide a new network configuration based on the network simulation analysis, wherein the new network configuration is estimated to improve network performance.

US20200336373 discloses a method for recommending configuration changes in a communications network. The method comprises maintaining a plurality of machine-learning processes, wherein an individual machine-learning process operates based on a data model and decision-making rules, and the plurality of machine-learning processes operate based on a plurality of different data models and a plurality of different decision-making rules. The method also comprises obtaining values of Key Performance Indicators, KPIs, from network elements of the characterizing wanted operation of the communications network. The method also comprises producing by the plurality of machine-learning processes, based on the received values of KPIs and using the data models and decision-making rules, a plurality of individual recommendations; and producing an output recommendation based on the produced individual recommendations.

WO2020121084 discloses system, method and non-transitory computer readable media for optimizing input data for a ML model associated with a communications network. In one implementation, example ML model(s) may be trained using a modified dataset obtained for a plurality of cellular aggregation units of the RAN infrastructure(s), wherein the modified dataset is derived from data collected for individual cellular aggregation units over a data collection period with respect to a plurality of KPI variables. The modified data set is optimized by replacement of null values of variables with corresponding modal values of the variables. The trained ML model may be used for predicting one or more KPIs based on a set of test data associated with the RAN infrastructure(s).

### SUMMARY OF INVENTION

The Applicant has recognized that the known prior-art solutions are not satisfactory.

Indeed, the Applicant has recognized that a network configuration which maximizes cellular network performance on the basis of the forecast KPI parameters is not an optimal network configuration, in that forecast procedures are affected by systematic forecast errors.

The Applicant has recognized that systematic forecast errors are mainly due to the fact that KPI parameters observations and processing require relatively long times (e.g., from 15′ to 1 hour). Since the historical KPI parameters may relate to far or relatively far time intervals, the historical KPI parameters do not reflect an actual condition of the cellular network at a current time interval, whereby a network configuration determined for the current time interval based on the historical KPI parameters is usually sub-optimal. This causes performance degradation, both in terms of time delays and in terms of stability of the configuration of the cellular network.

Systematic forecast errors may result in forecast KPI parameters based on incorrect assumptions on number of users connected to a network cell and/or on data traffic volume, and hence in sub-optimal network configurations.

In view of the above, the Applicant has tackled the above-mentioned issues, and has devised a method and system for optimizing the network configuration of a wireless network, such as a cellular network, based on the forecast KPI parameters, while mitigating the negative effects of the systematic forecast errors on the prediction of the optimal network configuration.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present invention that applies mutatis mutandis to any other aspect).

More specifically, an aspect of the present invention relates to a method for configuring a cellular network.

According to an embodiment, the method comprises measuring values of at least one performance indicator of the cellular network over a plurality of time intervals. According to an embodiment, the plurality of time intervals comprises a current time interval associated with a current network configuration of the cellular network and with current measured values of the at least one performance indicator and, before the current time interval, a plurality of historical time intervals each one associated with a respective historical network configuration of the cellular network and with respective measured historical values of the at least one performance indicator.

According to an embodiment, the method comprises determining, for each one of at least one selected historical time interval of said plurality of historical time intervals, a plurality of alternative network configurations that could have been implemented by the cellular network during the corresponding historical time interval in alternative to the respective historical network configuration.

According to an embodiment, the method comprises determining, for each alternative network configuration, respective simulated values of the at least one performance indicator.

According to an embodiment, the method comprises, based on the measured historical and simulated values of the at least one performance indicator, determining, for each selected historical time interval, a respective best network configuration among the respective historical network configuration and the respective plurality of alternative network configurations.

According to an embodiment, the method comprises, based on the current and measured historical values of the at least one performance indicator, determining forecast values of the at least one performance indicator for a following time interval following the current time interval.

According to an embodiment, the method comprises, based on the forecast values of the at least one performance indicator, on the measured historical values of the at least one performance indicator and the best network configurations determined for each selected historical time interval, predicting an optimal network configuration for the following time interval.

According to an embodiment, the method comprises, at the following time interval, configuring the cellular network according to the predicted optimal network configuration.

According to an embodiment, the method comprises training a machine learning model with the measured historical values of the at least one performance indicator and the best network configurations.

According to an embodiment, said predicting an optimal network configuration for the following time interval is performed by the trained machine learning model according to the forecast values of the at least one performance indicator.

According to an embodiment, said determining, for each selected historical time interval, a respective best network configuration comprises, for each selected historical time interval:
determining respective values of a reward function each one associated with a respective reference network configuration among the respective historical network configuration and the respective plurality of alternative network configurations, and
determining the best network configuration as the reference network configuration that results in a maximum value of the reward function.

According to an embodiment, the reward function comprises a linear combination among two or more functions each one indicative of a relationship between the values of the at least one performance indicator and a parameter of the cellular network.

According to an embodiment, for each selected historical time interval, each reference network configuration is associated with a respective network operating condition, such as network traffic behavior, that may reasonably be expected in that selected historical time interval.

According to an embodiment, each reference network configuration is determined by an optimization technique comprising at least one between a “Coverage and Capacity Optimization” algorithm and a “Mobility Load Balancing” technique.

According to an embodiment, the method comprises, for each selected historical time interval, aggregating the respective measured historical and simulated values of the at least one performance indicator per network cell.

According to an embodiment, said determining forecast values of the at least one performance indicator comprises determining the forecast values of the at least one performance indicator based on said aggregating.

According to an embodiment, said determining the forecast values of the at least one performance indicator based on said aggregating comprises determining the forecast values of the at least one performance indicator for network cells of the cellular network whose measured and simulated historical values of the at least one performance indicator have been used for determining the best network configuration.

According to an embodiment, said determining, for each alternative network configuration, respective simulated values of the at least one performance indicator is based on at least one between:
geo-localized procedure and/or event traces collected by network elements of the cellular network; and
radio measurements combined with positioning information, reported by user devices connected to the cellular network.

Another aspect of the present invention relates to a system configured to perform the method of the above.

According to an embodiment, the system comprises at least one measuring entity for measuring values of at least one performance indicator of a cellular network over a plurality of time intervals, the plurality of time intervals comprising a current time interval associated with a current network configuration of the cellular network and with current measured values of the at least one performance indicator and, before the current time interval, a plurality of historical time intervals each one associated with a respective historical network configuration of the cellular network and with respective measured historical values of the at least one performance indicator.

According to an embodiment, the system comprises a determining unit for determining, for each one of at least one selected historical time interval of said plurality of historical time intervals, a plurality of alternative network configurations that could have been implemented by the cellular network during the corresponding historical time interval in alternative to the respective historical network configuration;

According to an embodiment, the system comprises a network simulator unit for determining, for each alternative network configuration, respective simulated values of the at least one performance indicator.

According to an embodiment, the system comprises a computation unit for determining, based on the measured historical and simulated values of the at least one performance indicator, and for each selected historical time interval, a respective best network configuration among the respective historical network configuration and the respective plurality of alternative network configurations.

According to an embodiment, the system comprises a forecast unit for determining, based on the current and measured historical values of the at least one performance indicator, forecast values of the at least one performance indicator for a following time interval following the current time interval.

According to an embodiment, the system comprises a predicting unit for predicting, based on the forecast values of the at least one performance indicator, on the measured historical values of the at least one performance indicator and the best network configurations determined for each selected historical time interval, an optimal network configuration for the following time interval.

According to an embodiment, the system comprises a configuration unit for configuring, at the following time interval, the cellular network according to the predicted optimal network configuration.

### BRIEF DESCRIPTION OF THE ANNEXED DRAWINGS

These and other features and advantages of the invention will be made apparent by the following description of some exemplary and non-limitative embodiments thereof. For its better intelligibility, the following description should be read making reference to the attached drawings, wherein:

FIG. 1 schematically shows a cellular communication system according to an embodiment of the present invention, and

FIG. 2 schematically shows an activity flow of a method implemented in the cellular communication system, according to an embodiment of the present invention.

### DETAILED DESCRIPTION OF PREFERRED EMBODIMENTS OF THE INVENTION

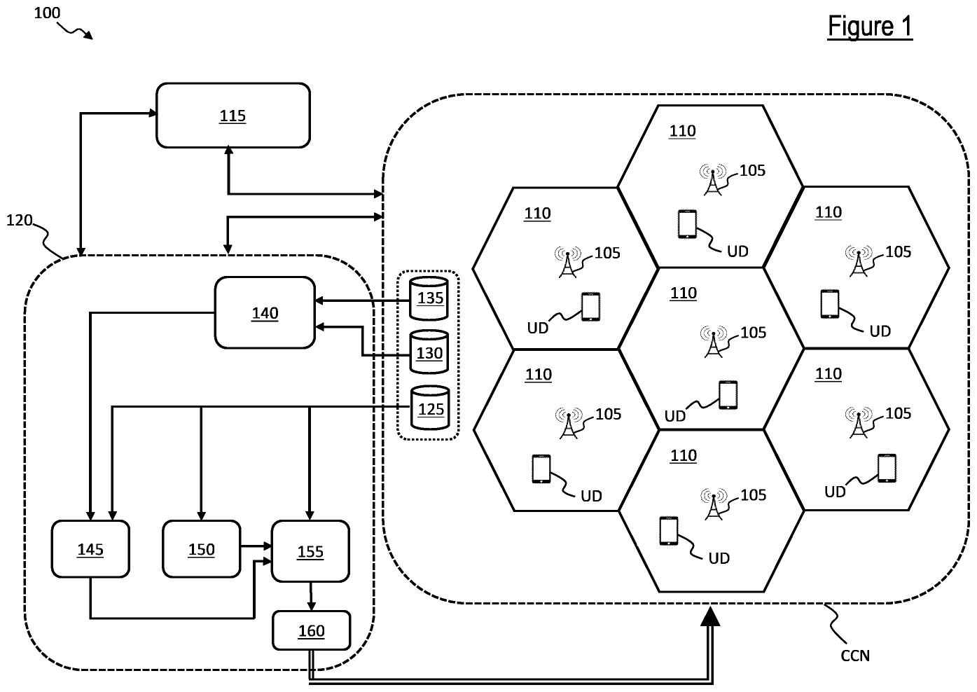

With reference to the drawings, a wireless (e.g., cellular) communication system 100 (i.e., a portion thereof) according to an embodiment of the present invention is schematically illustrated in FIG. 1.

In the following, when one or more features of the cellular communication system 100 (and of a method implemented by it) are introduced by the wording “according to an embodiment”, they are to be construed as features additional or alternative to any features previously introduced, unless otherwise indicated and/or unless there is evident incompatibility among feature combinations that is immediately apparent to the person skilled in the art.

According to an embodiment, the cellular communication system 100 comprises a cellular communication network (hereinafter, concisely, cellular network) CCN.

According to an embodiment, the cellular network CCN comprises a plurality of cellular communication equipment 105 providing radio coverage over a geographic area.

According to an embodiment, each cellular communication equipment 105 is configured to provide radio coverage over (or, equivalently, is associated with) one or more portions of the geographic area, or network cells, 110.

In the exemplary, simplified scenario herein considered, each cellular communication equipment 105 is associated with a respective network cell 110. In a practical scenario, each cellular communication equipment 105 may be associated with a plurality of network cells, such as three network cells.

According to an embodiment, as exemplary illustrated, each network cell 110 is hexagonal in shape. In practice, though, a cell shape may differ significantly from an ideal hexagonal shape, e.g. due to geographical and/or propagation characteristics or constraints of the area where the cell is located.

According to an embodiment, the cellular communication equipment 105 allow user devices UD within the respective network cells 110 (and connecting/connected to the cellular communication system 100) to exchange data traffic (e.g., web browsing, e-mailing, voice, or multimedia data traffic).

The user devices UD may for example comprise personal devices owned by users of the cellular communication system 100 (the users being for example subscribers of services offered by the cellular communication system 100). Examples of user devices UD comprise, but are not limited to, mobile phones, smartphones, tablets, personal digital assistants and computers.

According to an embodiment, the cellular network CCN forms the radio access network.

The radio access network (and, more generally, the cellular communication system 100) may be based on any suitable radio access technology. Examples of radio access technologies include, but are not limited to, UTRA (“UMTS Terrestrial Radio Access”), WCDMA (“Wideband Code Division Multiple Access”), CDMA2000, LTE (“Long Term Evolution”), LTE-Advanced, and NR (“New Radio”).

According to an embodiment, the radio access network is communicably coupled with one or more core networks, such as the core network 115. The core network 115 may be any type of network configured to provide aggregation, authentication, call control/switching, charging, service invocation, gateway and subscriber database functionalities, or at least a subset (i.e., one or more) thereof.

According to an embodiment, the core network 115 comprises a 4G/LTE core network or a 5G core network.

According to an embodiment, the core network 115 is communicably coupled with other networks, such as the Internet and/or public switched telephone networks (not shown).

According to an embodiment, the cellular communication system 100 is provided with “Self-Organizing Network” (SON) functionalities, i.e. functionalities that allow setting (i.e., tuning or adjusting) one or more parameters of the cellular network CCN. According to an embodiment, the parameters of the cellular network CCN define a configuration of the cellular network CCN (hereinafter, concisely, network configuration).

Examples of parameters of the cellular network CCN include, but are not limited to, parameters of the network cells 110 (hereinafter, cell parameters), such as transmission power, antenna electrical tilt, antenna azimuth, antenna gain and antenna radiation pattern (e.g., pointing direction, directivity and width of one or more lobes of the pattern of lobes exhibited by the antenna radiation pattern).

According to an embodiment, the cellular communication system 100 comprises a SON module 120, i.e. a processing module that allows implementing the SON functionalities. The SON module 120 (as well as one or more units thereof, discussed in the following), may be implemented by software, hardware, and/or a combination thereof.

According to an embodiment, the network configurations are set or adjusted through proper commands (hereinafter referred to as SON commands) from the SON module 120 to the cellular network CCN.

According to an embodiment, the SON module 120 is located external to both the cellular network CCN and the core network 115. According to alternative embodiments, the SON module 120 is located (at least partially) in the core network 115 (e.g., in one or more units thereof) or in any other entity of the cellular network or of the cellular communication system 100. According to an embodiment, the physical location of the SON module 120 depends on the implemented SON network architecture (e.g., distributed SON network, centralized SON network or hybrid SON network).

According to an embodiment, the SON module 120 is configured to perform a method (hereinafter, SON method) for configuring the cellular network CCN.

According to an embodiment, the SON method is based on measurements of values of one or more parameters relating to the operation of the cellular network CCN (hereinafter, operating parameters).

According to an embodiment, the measurements of the values of the operating parameters may be performed by any suitable entity (e.g., one or more measuring entities) of (or connected to) the cellular communication system 100. According to an embodiment, the measurements of the values of the operating parameters are collected by the SON module 120. According to an embodiment, the measurements of the values of the operating parameters are collected by the SON module 120 based on proper signaling exchange with the cellular network CCN (and/or with the user devices UD connected thereto, as better discussed in the following) and/or with the core network 115 (this is conceptually represented in the figure by a double-headed arrow between the SON module 120 and the cellular network CCN, and a double-headed arrow between the SON module 120 and the core network 115).

According to an embodiment, the operating parameters comprise one or more performance indicators (typically denoted as “Key Performance Indicators” in cellular communication networks, hereinafter KPI parameters). Examples of KPI parameters include, but are not limited to, average number of users connected to the cellular network CCN, average downlink data traffic volume, average uplink data traffic volume, and average number of active users per network cell (or, equivalently, average traffic level per network cell).

In the following, reference will be made to a KPI parameter as an example of operating parameter, although this should not be construed limitatively. In the following, the values of a KPI parameter (or of other operating parameter(s)) will be concisely referred to as KPI values.

According to an embodiment, the measurements of the KPI values are performed by proper performance counters (not shown) of the cellular network CCN. According to an embodiment, the performance counters are implemented in the cellular communication equipment 105.

According to an embodiment, the cellular communication system 100 comprises one or more network databases.

According to an embodiment, the network databases comprise a network database (hereinafter, KPI database) 125 configured to store measured KPI values being measured over time. According to an embodiment, the KPI database 125 is configured to store the measured KPI values for each network cell 110. According to an embodiment, the KPI database 125 is configured to store the measured KPI values being measured during a number of time intervals within a predetermined time period. Just as an example, each time intervals may be of the order of hour or fraction of hour, and the time period may be of the order of one or more days or months. For the purposes of the present disclosure, each time interval is associated with a respective network configuration of the cellular network CCN.

According to an embodiment, the KPI database 125 is configured to store current measured KPI values (i.e., measured KPI values being measured during a current time interval associated with a current network configuration) and measured historical KPI values (i.e., measured KPI values being measured during a plurality of historical or past time intervals, before the current time interval, each one associated with a respective historical network configuration).

According to an embodiment, the KPI database 125 is located in the cellular network CCN. According to an alternative embodiment, not shown, the KPI database 125 is located in the core network 115 (e.g., in one or more units thereof). Without losing generality, the KPI database 125 may be located in any other entity of the cellular network CCN or of the cellular communication system 100.

According to an embodiment, the network databases comprise a network configuration database (hereinafter, NC database) 130 configured to store the network configurations.

According to an embodiment, the NC database 130 is configured to store a current network configuration (i.e., the network configuration of the cellular network CCN during the current time interval) and historical network configurations (i.e., the network configurations of the cellular network CCN before the current time interval, for example during the historical time intervals, or a subset thereof, before the current time interval).

According to an embodiment, the NC database 130 is located in the cellular network CCN. According to an alternative embodiment, not shown, the NC database 130 is located in the core network 115 (e.g., in one or more units thereof). Without losing generality, the NC database 130 may be located in any other entity of the cellular network CCN or of the cellular communication system 100.

Therefore, each time interval (i.e., the current time interval and each historical time interval) is associated with respective measured KPI values (i.e., the current measured KPI values and the respective measured historical KPI values) and with a respective network configuration (i.e., the current network configuration and the respective historical network configuration).

According to an embodiment, the network databases comprise a network database (hereinafter, MP database) 135 configured to store one or more network parameters of the cellular network CCN. According to an embodiment, the network parameters comprise a signal strength (or signal level) of each network cell 110.

According to an embodiment, the signal level is determined based on procedure and/or event traces collected by one or more entities (such as the cellular communication equipment 105) of the cellular communication system 100.

According to procedure and/or event traces, for each user device UD connected to the cellular communication system 100, procedures and/or events (including, but are not limited to, voice call, data call, and related signaling procedures) are traced, e.g. in order to allow periodically detecting the signal levels associated with a respective serving network cell as well as with network cells adjacent thereto.

According to an embodiment, the traced procedures and/or events are geo-localized traced procedures and/or events.

According to an embodiment, geo-localizations of the traced procedures and/or events is achieved by means of one or more among “Timing Advance” information (e.g., if the cellular communication system 100 is a LTE/LTE-Advanced cellular communication system), “Angle of Arrival” information (e.g., if the cellular communication system 100 is a 5G cellular communication system), “Global Navigation Satellite System” (GNSS)/“Assisted Global Navigation Satellite System” (A-GNSS) information, and triangulation techniques.

According to an embodiment, the signal levels are determined, additionally or alternatively to procedure and/or event traces reported from the network elements, based on radio measurements reported by the user devices UD connected to the cellular network CCN. According to an embodiment, radio measurement reporting is performed by the user devices UD through “Minimization of Drive Test” (MDT) functionality.

Examples of radio measurements include, but are not limited to, RSRP (“Received Signal Received Power”), RSRQ (“Received Signal Received Quality”), RSCP (“Received Signal Code Power”), “Pilot Chip Energy to Interference Power Spectral Density”, “Data Volume”, scheduled IP throughput, packet delay, packet loss rate, RTT (“Round Trip Time”) and RXTX_TIMEDIFF measurements.

According to an embodiment, the radio measurements reported by each user device UD may comprise layer information, i.e. information about frequency layers (or frequency bands, such as 800 MHZ, 1800 MHZ, 2600 MHZ) through which the user device UD may perform data transmission/reception in the respective serving network cell.

By using the MDT functionality, the radio measurements reported by the user devices UD are advantageously combined with positioning information. Positioning information may for example be provided by the user devices UD (e.g., by exploiting GPS and/or GNSS/A-GNSS functionalities thereof) and/or computed by the cellular communication system 100 (e.g., by the core network 115) based on the radio measurements. Examples of positioning information computed by the cellular communication system 100 include, but are not limited to, ranging measurements based on localization signals emitted by any properly configured cellular communication equipment, and/or triangulations on signals of the cellular network.

In the following, the geo-localized procedures and/or events traces, and/or the radio measurements (combined with positioning information) reported by the user devices UD (for example, through MDT functionality) will be concisely referred to as geo-localized tracing/reporting data.

According to an embodiment, the MP database 135 is located in the cellular network CCN. According to an alternative embodiment, not shown, the MP database 135 is located in the core network 115 (e.g., in one or more units thereof). Without losing generality, the MP database 135 may be located in any other entity of the cellular network CCN or of the cellular communication system 100.

According to an embodiment, the cellular communication system 100 comprises a network simulator unit 140.

Broadly speaking, the network simulator unit 140 features electromagnetic simulation functionalities aimed at providing, over the geographic area, estimates of the effects that network configuration changes have on the area coverages of the network cells 110 within the geographic area.

According to an embodiment, as better discussed in the following, the network simulator unit 140 is configured to determine, for each selected historical time interval and for each alternative network configuration that could have been implemented by the cellular network CCN during the selected historical time interval in alternative to the respective historical network configuration, respective simulated historical KPI values. In practice, as alternative network configuration that could have been implemented by the cellular network CCN, a number of reference network configurations can be considered, in particular tested and validated network configurations. According to an embodiment, the alternative network configurations may be stored in any entity of (or connected to) the cellular network CCN. According to an embodiment, the alternative network configurations may be stored in the network simulator unit 140.

According to an embodiment, electromagnetic simulation provided by the network simulator unit 140 may be based on morphological information of the geographic area (such as presence of roads and/or building, and size thereof).

According to an embodiment, electromagnetic simulation provided by the network simulator unit 140 may be based on the geo-localized tracing/reporting data. This is conceptually represented in the figure by an arrow connection between the network simulator unit 140 and the MP database 135.

According to an embodiment, electromagnetic simulation provided by the network simulator unit 140 may be based on proper a priori data. Examples of a priori data comprise, but are not limited to, estimates of user distribution among the network cells 110 of the cellular network CCN (hereinafter, user distribution estimates). User distribution estimates may for example take into consideration user seasonal movements (for example, when users move from cities to holiday resorts), number of users connected to the cellular network, and user habits.

According to an embodiment, based on evaluations on QOS (“Quality of Service”) level changes over the cellular network CCN (evaluations which may for example be determined based on the geo-localized tracing/reporting data), the electromagnetic simulation provided by the network simulator unit 140 may additionally estimate variations in KPI value aggregation policies (as better discussed in the following).

An example of a network simulation tool implementing the network simulator unit 140 is disclosed, for example, in EP1329120B1, in the name of the same Applicant hereto.

In the exemplary illustrated embodiment, the network simulator unit 140 is located in the SON module 120. In alternative embodiments, the network simulator unit 140 may be located, at least partially, in the cellular network CCN, and/or in the core network 115. Without losing generality, the network simulator unit 140 may be located, at least partially, in any entity of the cellular network CCN or of the cellular communication system 100.

According to an embodiment, the cellular communication system 100 comprises a computation unit 145.

According to an embodiment, the computation unit 145 is configured to receive the simulated historical KPI values (from the network simulator unit 140) and the measured historical KPI values (from the KPI database 125), and to determine, for each selected historical time interval, a best network configuration among the respective historical network configuration (i.e., the network configuration actually implemented in that historical time interval) and the respective alternative network configurations (i.e., network configurations that, although potentially available for that historical time interval, were not implemented).

According to an embodiment, the computation unit 145 is configured to, for each selected historical time interval, aggregate the respective simulated historical KPI values (i.e., the historical KPI values simulated for the respective alternative network configurations) and the respective measured historical KPI values (i.e., the historical KPI values measured for the respective historical network configuration) per network cell (hereinafter, KPI value aggregation). As better understood from the following discussion, KPI value aggregation allows determining forecast KPI values for those network cells that are associated with the simulated and measured historical KPI values used for determining the values of a reward function.

As mentioned above, variations in KPI value aggregation policies may be estimated (e.g., based on the electromagnetic simulation provided by the network simulator unit 140) based on QoS level changes (throughout the cellular network CCN) determined, for example, based on the geo-localized tracing/reporting data and/or on user distribution estimates or evaluations or hypothesis (for example, user distribution estimates or evaluations or hypothesis based on morphological information of the geographic area and/or on data different from the geo-localized tracing/reporting data).

As better discussed in the following, according to an embodiment the computation unit 145 is configured to determine, for each selected historical time interval, respective values of a reward function (the reward function being a function of the KPI values, as better discussed in the following), wherein each value of the reward function is associated with a respective (alternative or historical) network configuration (i.e., with respective simulated or measured historical KPI values), and to determine, for each selected historical time interval, the best network configuration for the selected historical time interval as the network configuration that results in an optimal (e.g., maximum or highest) value of the reward function.

As should be understood, for each selected historical time interval, the respective best network configuration determined by the computation unit 145 may be either the respective historical network configuration itself, or one among the respective alternative network configurations.

In the exemplary illustrated embodiment, the computation unit 145 is located in the SON module 120. In alternative embodiments, the computation unit 145 may be located, at least partially, in the cellular network CCN, and/or in the core network 115. Without losing generality, the computation unit 145 may be located, at least partially, in any entity of the cellular network CCN or of the cellular communication system 100.

According to an embodiment, the cellular communication system 100 comprises a forecast unit 150.

According to an embodiment, the forecast unit 150 is configured to, based on the current and historical measured KPI values, determine forecast KPI values for a following time interval succeeding or following the current time interval. According to an embodiment, the following time interval for which the forecast KPI values are determined may follow the current time interval by an amount of time of the order of hour, fraction of hour or multiple of hour. Just as an example, the following time interval may follow the current time interval by 90 minutes.

For the purposes of the present disclosure, the forecast KPI values may comprise direct or deterministic KPI values and/or indirect or probabilistic KPI values. Just as an example, the probabilistic KPI values may be expressed as a probabilistic distribution of the KPI values (for example, a probability mass function of the KPI values or a probability density function of the KPI values).

According to an embodiment, the forecast KPI values are determined for a predefined network configuration. According to an embodiment, the predefined network configuration is determined based on the user distribution estimates.

According to an embodiment, the forecast unit 150 is configured to determine the forecast KPI values for those network cells which, based on KPI value aggregation, are associated with the simulated and measured historical KPI values that have been used for determining the values of the reward function.

Without losing generality, the forecast unit 150 may be based on statistical analysis models such as ARIMA (“Autoregressive Integrated Moving Average”) model, and/or recurrent neural networks such as LSTM (“Long-Short Term Memory”) network, and/or on feed forward neural networks such as CNN (“Convolutional Neural Networks”) network.

According to an embodiment, in response to operating changes made to the forecast unit 150, redetermination of the forecast KPI values for each selected historical time interval may take place at the forecast unit 150 based on the operating changes. Operating changes made to the forecast unit 150 may for example take place when refined models capable of increasing a forecast accuracy are adopted in place of existing models, and/or when the existing models are updated in response to changes in network cell behavior. Just as an example, changes in network cell behavior may take place due to user seasonal movements (for example, when users move from cities to holiday resorts), changes in the number of users connected to the cellular network, changes in user habits, changes in the geographic area covered by the cellular network CCN (for example the opening of a new mall), and/or changes in the cellular network CCN (for example the addition of a new cell site).

As better understood from the following discussion, redetermination of the forecast KPI values for the selected historical time intervals allows speeding up a re-training of a machine learning unit (discussed here below), which re-training may therefore be based on the redetermined forecast KPI values rather than on new forecast KPI values generated afresh by the changed forecast unit.

In the exemplary illustrated embodiment, the forecast unit 150 is located in the SON module 120. In alternative embodiments, the forecast unit 150 may be located, at least partially, in the cellular network CCN, and/or in the core network 115. Without losing generality, the forecast unit 150 may be located, at least partially, in any entity of the cellular network CCN or of the cellular communication system 100.

According to an embodiment, the cellular communication system 100 comprises a predicting unit 155, such as a machine learning unit.

According to an embodiment, as better discussed in the following, the machine learning unit 155 is configured to predict, based on the forecast KPI values, on the measured historical KPI values and on the best network configurations associated with the selected historical time intervals, an optimal network configuration for the following time interval. According to an embodiment, the machine learning unit 155 is configured to determine the optimal network configuration further based on historical forecast KPI values, i.e. the forecast KPI values (previously) output by the forecast unit 150 for the selected historical time intervals. According to an embodiment, the machine learning unit 155 is configured to determine the optimal network configuration further based on the simulated historical KPI values (i.e., the simulated KPI values (previously) output by the network simulator unit 140 for the selected historical time intervals).

According to an embodiment, the machine learning unit 155 is configured to implement a machine learning model.

According to an embodiment, the measured historical KPI values and the best network configurations associated with the selected historical time intervals are used as training data set for the machine learning model, the historical forecast KPI values are used as a target of the machine learning model (i.e., the values to which the results of the machine learning model run with the training data set are compared, to accordingly adjust the machine learning model), and the forecast KPI values are the values to which the trained machine learning model is applied to predict the optimal network configuration.

Without losing generality, the machine learning unit 155 may be implemented by any suitable machine learning technique. Examples of machine learning techniques include, but are not limited to, “K-Nearest Neighbors”, “Support Vector Machine”, “Random Forest”, and “Neural Networks” techniques.

In the exemplary illustrated embodiment, the machine learning unit 155 is located in the SON module 120. In alternative embodiments, the machine learning unit 155 may be located, at least partially, in the cellular network CCN, and/or in the core network 115. Without losing generality, the machine learning unit 155 may be located, at least partially, in any entity of the cellular network CCN or of the cellular communication system 100.

According to an embodiment, the cellular communication system 100 comprises a configuration unit 160 for configuring the cellular network CCN based on the predicted optimal network configuration. According to an embodiment, the configuration unit comprises a SON API (“Application Programming Interface) unit 160 for receiving from the machine learning unit 155 the predicted optimal network configuration (or an indication thereof), and for providing to the cellular network CCN the corresponding SON commands to set the cellular network CCN at the optimal network configuration.

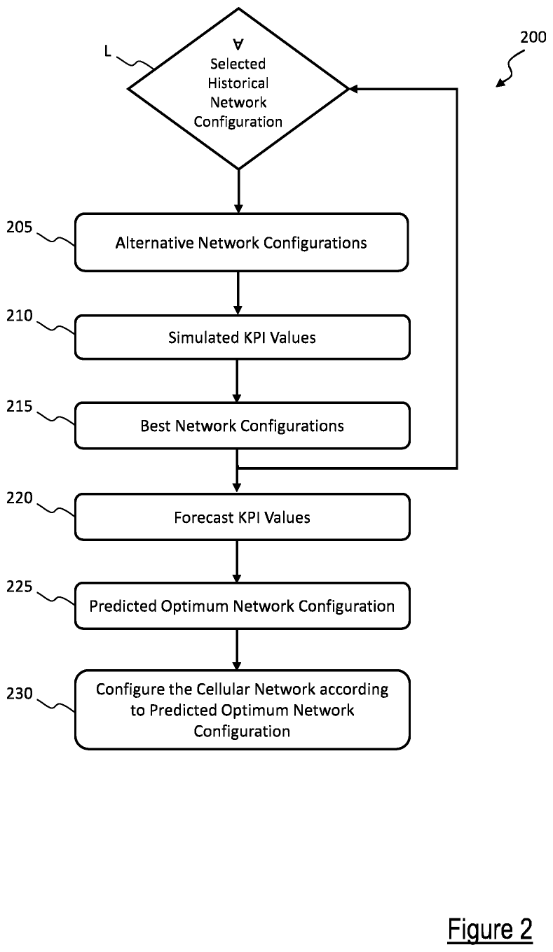

With reference to FIG. 2, it schematically shows an activity diagram of a SON method 200 according to an embodiment of the present invention.

According to an embodiment, the SON method 200 is implemented by the SON unit 120. However, this should not be construed limitatively: in fact, according to an embodiment, at least a subset of the method steps may be implemented by the core network 115, and/or by one or more other entities or modules (not shown) of the cellular communication system 100.

According to an embodiment, as mentioned above, the SON method 120 is aimed at predicting, at the current time interval, the optimal network configuration for the following time interval.

According to an embodiment, the SON method 200 comprises determining, for each selected historical time interval, the respective alternative network configurations (action node 205).

According to an embodiment, determination, for each selected historical time interval, of the respective alternative network configurations may be carried out at a determining unit (not shown). According to an embodiment, the determining unit may be a stand-alone unit, or a unit included in any other entity of (or connected to) the cellular network CCN (such as a unit included in any of the previous or following units or modules the cellular network CCN). Just as an example, the determining unit may be included in the network simulator unit 140 (although this should not be construed limitatively).

According to an embodiment, the selected historical time intervals may comprise any historical time intervals before the current time interval.

According to an embodiment, the selected historical time intervals may comprise a subset of the historical time intervals before the current time interval. Just as an example, the subset of the historical time intervals may comprise a predetermined number of historical time intervals before the current time interval (e.g., so as to exclude historical time intervals that may be considered statistically not relevant, for example in that they relate to exceptional conditions of the cellular network and/or in that they are too far in the past with respect to the current time interval).

According to an embodiment, the alternative network configurations associated with each selected historical time interval comprise reference network configurations that have been tested and validated by an operator of the cellular network (e.g., by the O&M (Operation & Maintenance) personnel). According to an embodiment, each validated alternative network configuration comprises a predefined network configuration that balances requirements of design and/or operative constraints (such as, radiated power limits, critical area coverages) and maximum achievable performance under different traffic profiles (such as under different hypothesis or estimates of user distribution).

According to an embodiment, as better discussed in the following, the alternative network configurations associated with each selected historical time interval comprise reference network configurations each one associated with a respective network traffic behavior (or other network operating condition) that may reasonably be expected in that historical time interval (for example, by taking into account a time slot (e.g., a time of the day) corresponding to the historical time interval. According to an embodiment, the alternative network configurations associated with each selected historical time interval comprise reference network configurations each one associated with a respective average network traffic behavior (or other network operating condition) that is expected, on average, in that historical time interval (for example, by taking into account a time slot (e.g., a time of the day) for both working days and non-working days).

According to an embodiment, each reference network configuration is determined by means of an optimization technique. According to an embodiment, the optimization technique may comprise at least one between a “Coverage and Capacity Optimization” (CCO) technique and a “Mobility Load Balancing” (MLB) technique.

According to an embodiment, the SON method 200 comprises determining, for each alternative network configuration, the respective simulated KPI values (action node 210).

According to an embodiment, as discussed above, the simulated KPI values are determined based on electromagnetic simulations performed by the network simulator unit 140 and/or on the geo-localized tracing/reporting data and/or on user distribution estimates or evaluations or hypothesis.

According to an embodiment, the SON method 200 comprises determining, for each selected historical time interval, the best network configuration among the respective historical network configuration and the respective alternative network configurations based on the measured and simulated values of the performance indicator (action node 215).

According to an embodiment, as mentioned above, the best network configurations are determined at the computation unit 145.

According to an embodiment, as mentioned above, at action node 215 the SON method 200 comprises determining, for each selected historical time interval, respective values of the reward function (wherein each value of the reward function is associated with a respective network configuration), and determining, for each selected historical time interval, the best network configuration for the selected historical time interval as the network configuration that results in an optimal value of the reward function.

According to an embodiment, the reward function is a function of the KPI values.

According to an embodiment, the reward function may be a function of the KPI values of two or more KPI parameters.

According to an embodiment, the reward function comprises a linear combination among two or more functions (hereinafter, remuneration functions). According to an embodiment, each remuneration function is indicative of a relationship between a parameter (hereinafter, remuneration parameter) of the cellular network and one or more KPI parameters. As better understood from the following discussion, each remuneration parameter may be indicative of a network traffic behavior (or other operating condition) of the cellular network.

An example of reward function F_{reward} comprising a linear combination of (e.g., three) remuneration functions each one determined for a respective network traffic behavior may be the following:

$${F}_{reward} = {\sum }_{n} {THR}_{cell} ( {KPI}_{n} ) * {k}_{1} + {THR}_{user} ( {KPI}_{n} ) * {k}_{2} + {THR}_{user , sub} ( {KPI}_{n} ) * {k}_{3}$$

wherein:
   THR_{cell} represents a first remuneration function, suitable for low traffic conditions, indicative of a relationship between one or more KPI parameters (such as the “Signal-to-Interference-plus-Noise Ratio” (SINR)) and an average cell throughput (remuneration parameter of the cellular network), and aimed at maximizing network capacity;
   THRᵤₛₑᵣ represents a second remuneration function, indicative of a relationship between one or more KPI parameters (such as SINR and/or average number of active users per network cell) and an average user throughput (remuneration parameter of the cellular network);
   THR_{user,sub} represents a third remuneration function, suitable for usual peak traffic conditions, indicative of a relationship between one or more KPI parameters (such as SINR) and a sublinear average cell throughput (remuneration parameter of the cellular network), and aimed at maximizing an equilibrium among user throughputs (e.g., so as to allocate more capacity in areas of the cellular network where a large number of users is expected in peak hours, thus getting a more equilibrated Quality of Service among network cells without pursuing an optimal network configuration per network cell);
n represents the (historical or alternative) reference network configuration;
notations Σ, THR_{cell} (KPIₙ), THRᵤₛₑᵣ (KPIₙ) and THR_{user,sub} (KPIₙ) denote that, for each selected historical time interval, the reward function F_{reward} is evaluated according to the KPI parameters KPIₙ associated with each respective n-th reference network configuration (i.e., the KPI parameters associated with the respective historical network configuration and the KPI parameters associated with the respective alternative network configurations); and
k₁, k₂ and k₃ are coefficients that depend on the network traffic behavior of the cellular network.

According to an embodiment, each coefficient k₁, k₂ and k₃ may take value “1” or value “0” according to the network traffic behavior of the cellular network. Considering, just as an example, the average traffic level per network cell affected by traffic congestion, coefficients k₁, k₂ and k₃ may be set as follows:
k₁=1, k₂=0, k₃=0, if the average traffic level per network cell is lower than an “Off-Peak” (OP) threshold. In this case, the reward function F_{reward} is mainly determined by the first remuneration function THR_{cell} (KPI1) (maximization of network capacity);
k₁=0, k₂=0, k₃=1, if the average traffic level per network cell is higher than an “Over Target” (OV) threshold. In this case, the reward function F_{reward} is mainly determined by the third remuneration function THR_{user,sub} (KP13) (maximization of an equilibrium among user throughputs);
k₁=1, k₂=1, k₃=0 if the average traffic level per network cell is higher than the OP threshold and lower than the OV threshold. In this case, the reward function F_{reward} is mainly determined by the combination of the first THR_{cell} (KPI1) and second THRᵤₛₑᵣ(KP12) remuneration functions.

According to an embodiment, each coefficient k₁, k₂ and k₃ may take one or more values between value “1” and value “0”, e.g. so as to take into account different and/or more complex network traffic behaviors.

Another example of reward function F_{reward} comprising a linear combination of (e.g., two) remuneration functions each one determined for a respective network traffic behavior may be the following:

$${F}_{reward} = {\sum }_{n} {THR}_{user , 50} ( {KPI}_{n} ) * {p}_{1} + {THR}_{user , 5} ( {KPI}_{n} ) * {p}_{2}$$

wherein:
THR_{user,50} is the renumeration function representing the value of the 50^{th} percentile of a user throughput distribution in territorial portions (or pixels) of the geographic area—as mentioned above, the average user throughput (remuneration parameter) depends on the “Signal-to-Interference-plus-Noise Ratio” and on the average number of active users per network cell (KPI parameters);
THR_{user,5} is the remuneration function representing the value of the 5^{th} percentile of the user throughput distribution in the territorial pixels—as mentioned above, the average user throughput (remuneration parameter) depends on the “Signal-to-Interference-plus-Noise Ratio” and on the average number of active users per network cell (KPI parameters);
   n represents the (historical or alternative) reference network configuration;
   notations Σ, THR_{user,50} (KPIₙ), and THR_{user,5} (KPIₙ) denote that, for each selected historical time interval, the reward function F_{reward} is evaluated according to the KPI parameters KPIₙ associated with each n-th respective reference network configuration (i.e., the KPI parameters associated with the respective historical network configuration and the KPI parameters associated with the respective alternative network configurations); and
p₁ and p₁ represent respective weights of the linear combination.

In other words, in this second example, the reward function F_{reward} is represented by a weighted average between the values of the 50^{th} percentile and of the 5^{th} percentile of the user throughput distribution in the territorial pixels.

As should be understood, each historical time interval (or, more generally, each time interval) may comprise same or different reference network configurations, and hence same or different values of the remuneration functions (or, equivalently, same or different values of the reward function).

Considering a generic historical time interval, and considering three reference network configurations NC1, NC2, NC3 associated with that historical time interval (n=3), the historical network configuration may be (depending on the optimal network configuration previously predicted for that historical time interval) one among the reference network configurations NC1, NC2, NC3, and the alternative network configurations are the remaining reference network configurations. Just as an example, the historical network configuration may be the network configuration NC1, and the alternative network configurations may be the network configurations NC2, NC3. In this example, the measured KPI values are associated with (i.e., measured for) the reference network configuration NC1 (e.g., assuming that the reference network configuration NC1 is the historical network configuration), and the simulated KPI values are simulated for the reference network configurations NC2 and NC3 (e.g., assuming that the reference network configurations NC2 and NC3 are the alternative network configurations).

In the example at issue, the best network configuration is determined, for the historical time interval, as the network configuration (among the reference network configurations NC1, NC2, NC3) that results in a maximum or highest value of the reward function F_{reward}.

As mentioned above, method steps performed at nodes 205, 210 and 215 are performed for each selected historical time interval. This is conceptually represented in the figure by loop connection between action node 215 and loop node L.

Back to the activity diagram, according to an embodiment the SON method 200 comprises, based on the current and historical measured KPI values, determining the forecast KPI values for the following time interval (action node 220).

As mentioned above, according to an embodiment the forecast KPI values are determined at the forecast unit 150 for a predefined network configuration, which may be determined based on the user distribution estimates.

As mentioned above, according to an embodiment, the forecast KPI values are determined for those network cells which, based on KPI value aggregation, are associated with the simulated and measured historical KPI values that have been used for determining the values of the reward function.

Back to the activity diagram, according to an embodiment the SON method 200 comprises, based on the forecast KPI values, the measured historical KPI values and the best network configurations determined for the selected historical time intervals, predicting the optimal network configuration for the following time interval (action node 225).

As mentioned above, according to an embodiment the optimal network configuration for the following time instant is predicted by the machine learning unit 155. According to an embodiment, as mentioned above, the measured historical KPI values and the best network configurations associated with the selected historical time intervals are used as training data set for the machine learning model implemented by the machine learning unit 155: this implies that the machine learning model is trained with systematic forecast errors systematically made by the forecast unit 150.

According to an embodiment, the machine learning unit 155 is configured to maximize a probability of correct determination of the optimal network configuration.

According to an embodiment, the machine learning unit 155 is configured to maximize a cost function depending on candidate network configurations each one evaluated in a respective state of the machine learning model, and on an estimated probability (hereinafter, configuration probability) that each candidate network configuration is the optimal network configuration. According to an embodiment, the cost function comprises a linear combination of candidate reward functions, wherein each candidate reward function is evaluated for a respective candidate network configuration and is weighted by the respective configuration probability. This allows achieving a weighted balance among the errors made throughout the states of the machine learning model, by mostly penalizing (and, hence, minimizing) errors with more relevant effects in terms of performance penalization.

Back to the activity diagram, according to an embodiment the SON method 200 comprises, at the following time interval, configuring the cellular network according to the predicted optimal network configuration (action node 230). According to an embodiment, as mentioned above, the cellular network is configured with the predicted optimal network configuration through the SON functionalities of the cellular communication system 100. According to an embodiment, as mentioned above, the cellular network is configured with the predicted optimal network configuration by the SON API unit 160, e.g. through the corresponding SON commands indicative of the predicted optimal network configuration.

The present invention allows the operator of the cellular network to react in advance to future network conditions, by reducing the possibility of implementing sub-optimal or non-optimal network configurations, and hence providing a superior quality of service to the users connected to the cellular network. This advantage is even more apparent when the forecast unit operates, for a given time interval, by assuming extreme network conditions (such as high concentrations of users and high traffic volumes) that actually do not arise. In these cases, the network configuration chosen on the basis of the forecast unit output alone (as in the prior-art solutions) would be directed to cope with these extreme situations, which would accordingly decrease the quality of service that would be possible to provide with a better choice of the optimal network configuration.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment as a matter of general design choice.

More specifically, the present invention lends itself to be implemented through an equivalent method (by using similar steps, removing some steps being not essential, or adding further optional steps); moreover, the steps may be performed in different order, concurrently or in an interleaved way (at least partly).

In addition, analogous considerations apply if the cellular communication system has a different structure or comprises equivalent components, or it has other operating features. In any case, any component or module or unit thereof may be separated into several elements, or two or more components or modules may be combined into a single element; in addition, each component or module or unit may be replicated for supporting the execution of the corresponding operations in parallel. It should also be noted that any interaction between different components generally does not need to be continuous (unless otherwise indicated), and it may be both direct and indirect through one or more intermediaries.

Without losing generality, the components or modules may be implemented in hardware, in software, and/or through a combination of hardware and software. If partly or wholly implemented in software, the corresponding components or modules may be run on dedicated hardware resources or on shared hardware resources, including cloud resources.

Moreover, although explicit reference has been made to an LTE/LTE-Advanced and 5G cellular communication systems, it should be understood that it is not in the intentions of the Applicant to be limited to the implementation of any particular cellular or wireless communication system architecture or protocol. In this respect, it is also possible to provide that, with suitable simple modifications, the proposed method may be applied to any other cellular or wireless communication systems (e.g., 3G cellular communications systems, or future generation wireless communication systems).

The invention claimed is:

1. Method for configuring a cellular network (CCN), the method comprising:
measuring values of at least one performance indicator of the cellular network over a plurality of time intervals, the plurality of time intervals comprising a current time interval associated with a current network configuration of the cellular network and with current measured values of the at least one performance indicator and, before the current time interval, a plurality of historical time intervals each one associated with a respective historical network configuration of the cellular network and with respective measured historical values of the at least one performance indicator;
determining, for each one of at least one selected historical time interval of said plurality of historical time intervals, a plurality of alternative network configurations that could have been implemented by the cellular network during the corresponding historical time interval in alternative to the respective historical network configuration;
determining, for each alternative network configuration, respective simulated values of the at least one performance indicator;
based on the measured historical and simulated values of the at least one performance indicator, determining, for each selected historical time interval, a respective best network configuration among the respective historical network configuration and the respective plurality of alternative network configurations;
based on the current and measured historical values of the at least one performance indicator, determining forecast values of the at least one performance indicator for a following time interval following the current time interval;
based on the forecast values of the at least one performance indicator, on the measured historical values of the at least one performance indicator and the best network configurations determined for each selected historical time interval, predicting an optimal network configuration for the following time interval, and
at the following time interval, configuring the cellular network according to the predicted optimal network configuration.

2. Method according to claim 1, further comprising training a machine learning model with the measured historical values of the at least one performance indicator and the best network configurations, wherein said predicting an optimal network configuration for the following time interval is performed by the trained machine learning model according to the forecast values of the at least one performance indicator.

3. Method according to claim 1, wherein said determining, for each selected historical time interval, a respective best network configuration comprises, for each selected historical time interval:
determining respective values of a reward function each one associated with a respective reference network configuration among the respective historical network configuration and the respective plurality of alternative network configurations, and
determining the best network configuration as the reference network configuration that results in a maximum value of the reward function.

4. Method according to claim 3, wherein the reward function comprises a linear combination among two or more functions each one indicative of a relationship between the values of the at least one performance indicator and a parameter of the cellular network.

5. Method according to claim 3, wherein, for each selected historical time interval, each reference network configuration is associated with a respective network operating condition, such as network traffic behavior, that may reasonably be expected in that selected historical time interval.

6. Method according to claim 3, wherein each reference network configuration is determined by an optimization technique comprising at least one between a “Coverage and Capacity Optimization” algorithm and a “Mobility Load Balancing” technique.

7. Method according to claim 1, further comprising, for each selected historical time interval, aggregating the respective measured historical and simulated values of the at least one performance indicator per network cell, said determining forecast values of the at least one performance indicator comprising determining the forecast values of the at least one performance indicator based on said aggregating.

8. Method according to claim 7, wherein said determining the forecast values of the at least one performance indicator based on said aggregating comprises determining the forecast values of the at least one performance indicator for network cells of the cellular network whose measured and simulated historical values of the at least one performance indicator have been used for determining the best network configuration.

9. Method according to claim 1, wherein said determining, for each alternative network configuration, respective simulated values of the at least one performance indicator is based on at least one between:
geo-localized procedure and/or event traces collected by network elements of the cellular network; and
radio measurements combined with positioning information, reported by user devices connected to the cellular network.

10. System comprising:
at least one measuring entity for measuring values of at least one performance indicator of a cellular network (CCN) over a plurality of time intervals, the plurality of time intervals comprising a current time interval associated with a current network configuration of the cellular network and with current measured values of the at least one performance indicator and, before the current time interval, a plurality of historical time intervals each one associated with a respective historical network configuration of the cellular network and with respective measured historical values of the at least one performance indicator;
a determining unit for determining, for each one of at least one selected historical time interval of said plurality of historical time intervals, a plurality of alternative network configurations that could have been implemented by the cellular network during the corresponding historical time interval in alternative to the respective historical network configuration;
a network simulator unit for determining, for each alternative network configuration, respective simulated values of the at least one performance indicator;
a computation unit for determining, based on the measured historical and simulated values of the at least one performance indicator, and for each selected historical time interval, a respective best network configuration among the respective historical network configuration and the respective plurality of alternative network configurations;
a forecast unit for determining, based on the current and measured historical values of the at least one performance indicator, forecast values of the at least one performance indicator for a following time interval following the current time interval;
a predicting unit for predicting, based on the forecast values of the at least one performance indicator, on the measured historical values of the at least one performance indicator and the best network configurations determined for each selected historical time interval, an optimal network configuration for the following time interval, and
a configuration unit for configuring, at the following time interval, the cellular network according to the predicted optimal network configuration.
